(19) United States
(12) Patent Application Publication
(10) Pub. No.: US 2008/0302630 A1
(43) Pub. Date: Dec. 11, 2008

(54) Loading ramps structure

(75) Inventor: Fu-Sheng Yang, Rende Shiang (TW)

Correspondence Address: BACON & THOMAS, PLLC, 625 SLATERS LANE, FOURTH FLOOR, ALEXANDRIA, VA, 22314-1176, US

(73) Assignee: HERCULES AUTOMOTIVE GROUP INC., RENDE SHIANG (TW)

(21) Appl. No.: 11/878,480

(22) Filed: Jul. 25, 2007

(30) Foreign Application Priority Data
Jun. 5, 2007 (TW) 96209218

(51) Int. Cl. B65G 69/30

(52) U.S. Cl. 193/41

(57) ABSTRACT

The loading ramps structure of the present invention includes: the first and the second ladder structure, respectively including two parallel side racks, several fixed crosswise racks set between said two side racks and pivotally-connecting section set on one end of said side rack, and one pivotally-connecting structure including one pair of the first pivotally-connecting pieces set on the side racks of the first ladder structure and one pair of the second pivotally-connecting pieces set on the side racks of the second ladder structure. The first and the second pivotally-connecting pieces jointly connect with the pivots fixed on both ends of the pivotally-connecting sections of the second ladder structure.

### BACKGROUND OF THE INVENTION

1) Field of the Invention

This invention relates to a loading ramps structure, whose pivotally connecting structure between two ladders can bear heavier loading, decrease packaging volume and increase strength of the ladder.

2) Description of the Prior Art

Loading ramps structure is applied frequently; when construction-vehicles driven down from truck or driven onto truck for carrying, loading ramps structure play an important role. Recently, since leisure and exercise are popular, recreation vehicles, such as ATV (all terrain vehicles), are also popular and they need to be carried by a truck with the help of a loading ramps structure. Normally, the usual loading ramps structure has an adequate length to be laid slantwise from the truck to the ground and two parallel straight forward side racks are set on both sides; moreover, several fixed crosswise racks are set at an adequate compartment between said two side racks to form a ladder structure. However, said structure is very long and inconvenient to be carried. A two-section loading-ramps structure, which is pivoted between the two sections of the loading ramps structure to fold the whole unit of the loading ramps structure to become half of its original length, has been applied to improve the convenience of carriage, but said structure has been found that the strength of said structure is not sturdy enough and the pivoted section is often broken-off when vehicle is boarding on the truck. When the vehicle is boarding on the truck, not only the weight of the vehicle but also the weight of the driver and the force driving tires to move on all exert on the ladder structure, since the pivoted section is the weakest point of the loading ramps structure, said section is easy to be broken-off.

### SUMMARY OF THE INVENTION

The objective of this invention is to provide an improved loading ramps structure, which includes: the first ladder structure including two parallel side racks, several fixed crosswise racks set between said two side racks and pivotally-connecting section set on one end of said side rack; the second ladder structure including two parallel side racks, several fixed crosswise racks set between said two side racks and pivotally-connecting section set on one end of said side rack, and one pivotally-connecting structure including one pair of the first pivotally-connecting pieces set on the side racks of the first ladder structure and one pair of the second pivotally-connecting pieces set on the side racks of the second ladder structure. The first and the second pivotally-connecting pieces jointly connect with the pivots fixed on both ends of the pivotally-connecting sections of the second ladder structure.

### BRIEF DESCRIPTION OF THE DRAWINGS

Other features and advantages of the present invention will become apparent in the following detailed description of the preferred embodiments, with reference to the accompanying drawings, in which:

FIG. 1 is a 3-D schematic view of the present invention preferred embodiments.

FIG. 2 is an enlarged schematic view of the pivotally-connecting section of the present invention preferred embodiments.

FIG. 3 is a schematic view of the folded-to-be-carried structure of the present invention preferred embodiment.

FIG. 4 is a cross-section schematic view of the structure of the handle-installing section of the present invention preferred embodiment.

FIG. 5 is a cross-section schematic view of the structure of the handle-keeping section of the present invention preferred embodiment.

### DETAILED DESCRIPTION OF THE PREFERRED EMBODIMENTS

In the detailed description of the preferred embodiments, it should be noted that like elements are indicated by the same reference numerals throughout the disclosure.

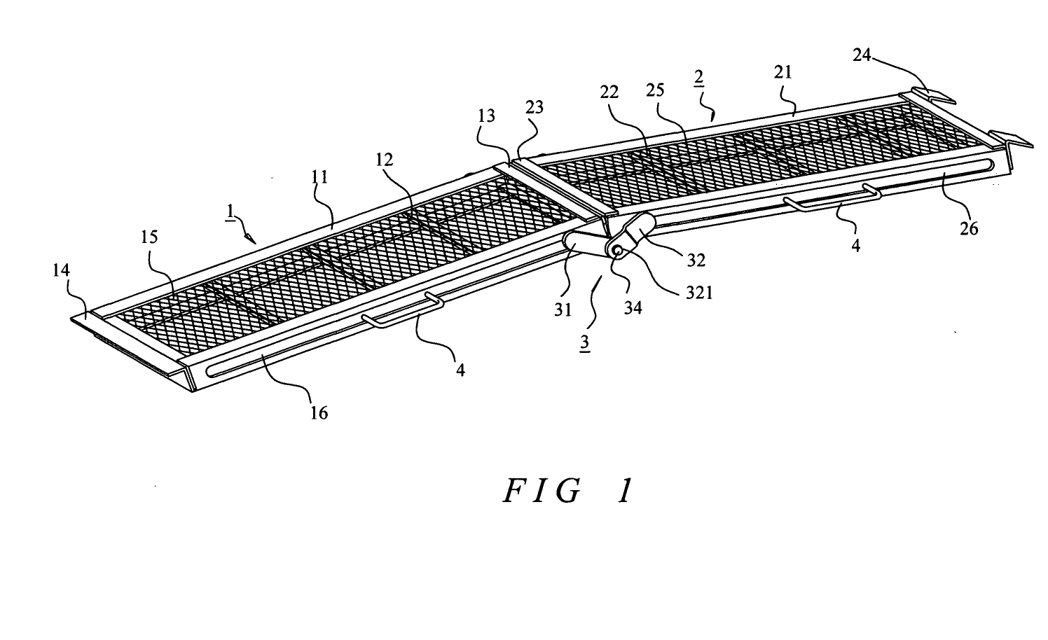

Referring to FIG. 1, the structure of the present invention preferred embodiment includes:

the first ladder structure 1 which is made of metal material includes two parallel side racks 11, fixed rack 12 whose number depends on the length of side rack 11 parallelly set at a suitable compartment between two side racks 11, pivotally-connecting section 13 set on the pivotally-connecting end on one end of side rack 11, grounding rack 14 set on the grounding end on the opposite end of the pivotally-connecting end of side rack 11, metal net 15 paved on the surface of fixed rack 12 between two side racks 11, and space 16 with long-sunken-strip formed on the side belly part of side rack 11;

the second ladder structure 2 which is made of metal material includes two parallel side racks 21, fixed rack 22 whose number depends on the length of side rack 21 parallelly set at a suitable compartment between two side racks 21, pivotally-connecting section 23 set on the pivotally-connecting end on one end of side rack 21, grounding rack 24 set on the grounding end on the opposite end of the pivotally-connecting end of side rack 21, metal net 25 paved on the surface of fixed rack 22 between two side racks 21, and space 26 with long-sunken-strip formed on the side belly part of side rack 21;

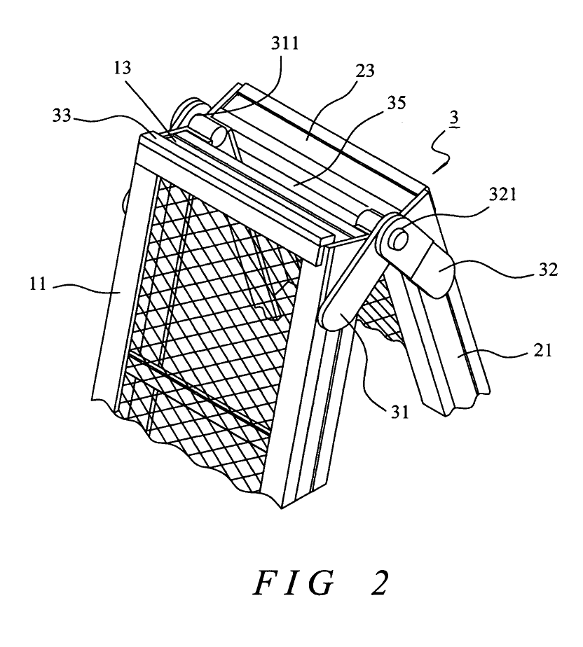

one pivotally-connecting structure 3, referring to FIG. 2, includes one pair of the first pivotally-connecting pieces 31 set on two side racks 11 outside corresponding to pivotally-connection section 13 of the first ladder structure 1; pivotally-connecting piece 31 is roughly long-strip-shaped and welded on side rack 11 at an adequate angle with the axis of side rack 11; the other un-welded end of pivotally-connecting piece 31 on where set an pivotally-connecting hole 311 outwardly extends to outside of side rack 11; furthermore, includes one pair of the second pivotally-connecting pieces 32 set on two side racks 21 outside corresponding to pivotally-connection section 23 of the second ladder structure 2; pivotally-connecting piece 32 is roughly long-strip-shaped and welded on side rack 21 at an adequate angle with the axis of side rack 21; the other un-welded end of pivotally-connecting piece 32 on where set an pivotally-connecting hole 321 outwardly extends to outside of side rack 21; pivotally-connecting holes 311 and 321 of pivotally-connecting piece 31 and 32 are overlapped and form a penetrated hole; one long-strip-shaped gasket 33 is welded on the position where is close to the upper side of pivotally-connecting section 13 of the first ladder structure 1 and parallel with pivotally-connecting section 13; moreover, one pivot 34 is respectively welded on both ends close to the lower side of pivotally-connecting section 23 of the second ladder structure 2 and one section of pivot 34 is parallel with pivotally-connecting section 23; a hollowed-out space 35 is formed between two pivots 34; each pivot 34 respectively extends outwardly and penetrates through overlapped-and-penetrated pivotally-connecting holes 311 and 321 of pivotally-connecting section 31 and 32 to couple said three components.

Making use of pivot 34 as an axis center, the first ladder structure 1 and the second ladder structure 2 can be unfolded as shown in FIG. 1 and grounding rack 14 of the first ladder structure 1 is landing on the ground, and fastening rack 24 on the fastening end of the second ladder structure 2 is fastening on the truck and slanting to lay down for unloading or loading vehicle; at the time, pivotally-connecting section 23 of the second ladder structure 2 is touching on gasket 33 welded on pivotally-connecting section 13 of the first ladder structure 1.

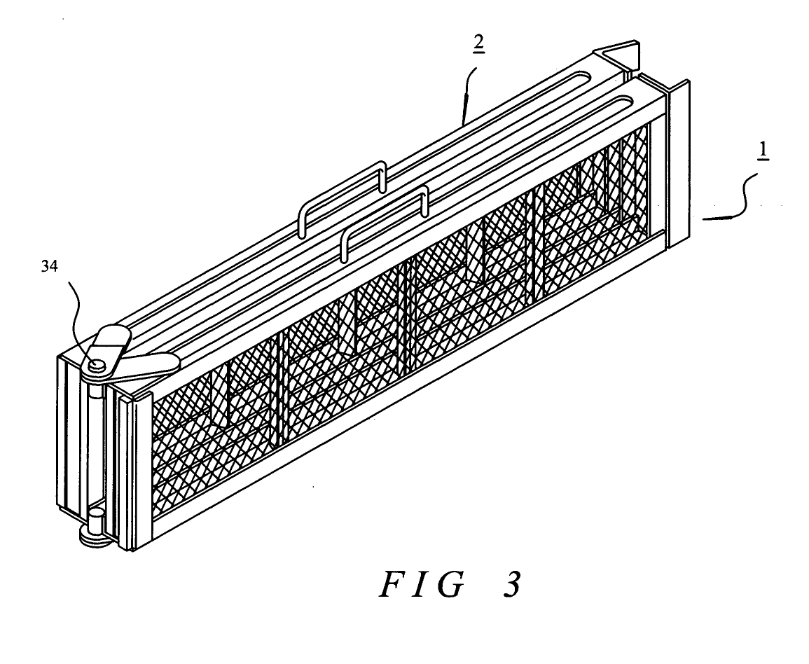

Referring to FIG. 3, the first ladder structure 1 and the second ladder structure 2 can be folded to about half of their original length via pivot 34 as an axle center to save the space of being carried by a truck.

The positions of the pair of the first pivotally-connecting pieces 31 of pivotally-connecting section 13 of the first ladder structure 1 on two pivots 34 locate at inner side comparing with the positions of the pair of pivotally-connecting pieces 32 of pivotally-connecting section 23 of the second ladder structure 2; in other words, the distance between the two first pivotally-connecting pieces 31 is closer than the distance between the two second pivotally-connecting pieces 32. The design is for matching the requirement of welding pivotally-connecting hole 321 of pivotally-connecting piece 32 on pivot 34 as a unit; however, in practical operation, when folding and unfolding the first ladder structure 1 and the second ladder structure 2, basically, there is no correspondingly-revolving movement happened between the second pivotally-connecting piece 32 and pivot 34; only the first pivotally-connecting piece 31 will proceed correspondingly-revolving movement around pivot 34. Meanwhile, when receiving external force, said design will also limit the first pivotally-connecting piece 31 to move outward to be loosened from pivot 34 to become damaged.

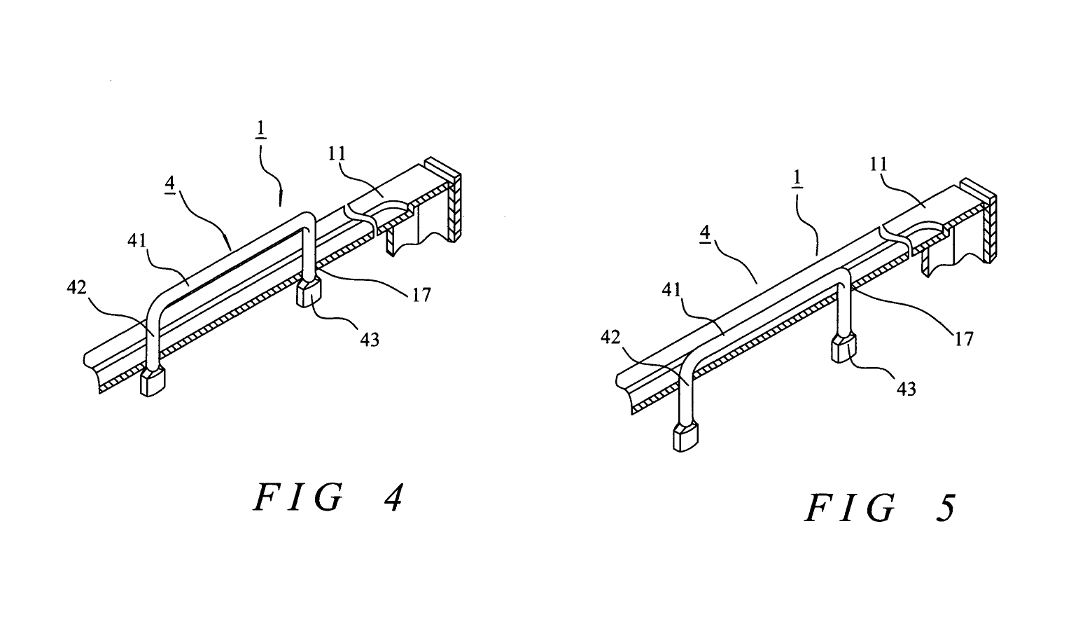

Furthermore, referring to FIG. 1 and FIG. 4, a handle 4 is respectively set on the respective corresponding-position of side rack 11 and 21 of the first ladder structure 1 and the second ladder structure 2 for carrying the whole unit of the landing ramps structure. Nevertheless, as shown in FIG. 4, taking the structure of handle 4 of side rack 11 of the first ladder structure 1 as an example, the handle on side rack 21 of the second ladder structure 2 can be set by parity of reasoning. The structure of handle 4 includes lateral holding section 41 and vertical fastening sections 42 on both ends; vertical fastening section 42 extends through penetrated hole 17 of side rack 11 of the first ladder structure 1 and forms a block section 43, whose, lateral width, is larger than, penetrated hole 17, on the, other end of penetrated hole 17. Hence, when holding lateral holding section 41 upward, block section 43 will block penetrated hole 17 set on side rack 11 and the first ladder structure 1 will be jointly holding upward. On the contrary, as shown in FIG. 5, when releasing the force holding lateral holding section, 41 upward, handle 4 will move downward and only lateral holding section 41 will appear outside of side rack 11; such kind of design will save transportation space via avoiding handle 4 bulging out.

Long-sunken-strip space 16, 26 on the side, belly part of side rack 11, 21 of the first ladder structure 1 and the second ladder structure 2 can fortify the strength of side rack 11, 21 to improve the loading capacity of the first ladder structure 1 and the second ladder structure 2.

Summing up foregoing description, the structure design of the present invention preferred embodiments not only can offer larger loading capacity of the pivot structure between the two ladder structure but also can decrease packaging volume and improve the strength of the ladder structures.

While the description of the present invention is made in connection with what is considered the, most practical and preferred embodiments, it is understood that this invention is not limited to the disclosed embodiments but intended to cover various arrangements included within the spirit and scope of the broadest interpretations and equivalent arrangements.

What is claimed is:

1. A loading ramps structure includes:
the first ladder structure including two parallel side racks, several fixed racks set between said two side racks and pivotally-connecting section set on one end of said side rack;
the second ladder structure including two parallel side racks, several fixed racks set between said two side racks and pivotally-connecting section set on one end of said side rack;
one pivotally-connecting structure including one pair of the first pivotally-connecting pieces set on the side racks of the first ladder structure and one pair of the second pivotally-connecting pieces set on the side racks of the second ladder structure; said first and second pivotally-connecting pieces jointly couple with the pivot set on both ends of the pivotally-connecting section of said second ladder structure.

2. A loading ramps structure as claimed in claim 1, wherein said one pivot is respectively welded on both ends close to the lower side of pivotally-connecting section of the second ladder structure and one section of said pivot is parallel with pivotally-connecting section; a hollowed-out space is formed between said two pivots.

3. A loading ramps structure as claimed in claim 1, wherein said the second pivotally-connecting piece is welded on pivot as a unit; however, when folding and unfolding the first ladder structure 1 and the second ladder structure 2, basically, there is no correspondingly-revolving movement happened between the second pivotally-connecting piece and pivot; only the first pivotally-connecting piece will proceed correspondingly-revolving movement around pivot.

4. A loading ramps structure as claimed in claim 1, wherein said the positions of the pair of the first pivotally-connecting pieces of pivotally-connecting section of the first ladder structure on the two pivots locate at inner side comparing with the positions of the pair of pivotally-connecting pieces of pivotally-connecting section of the second ladder structure; in other words, the distance between the two first pivotally-connecting pieces is closer than the distance between the two second pivotally-connecting pieces.

5. A loading ramps structure as claimed in claim 1, wherein said the first and the second pivotally-connecting pieces are roughly long-strip-shaped and welded on side rack at an adequate angle with the axis of side rack; the other un-welded end of pivotally-connecting piece on where set an pivotally-connecting hole outwardly extends to outside of side rack.

6. A loading ramps structure as claimed in claim 1, wherein said metal net is paved on the surface of fixed racks between two side racks.

7. A loading ramps structure as claimed in claim 1, wherein said long-sunken-strip space is formed on the side belly part of the side rack of the first and the second ladder structure.

8. A loading ramps structure as claimed in claim 1, wherein said one long-strip-shaped gasket is welded on the position where is close to the upper side of pivotally-connecting section of the first ladder structure.

9. A loading ramps structure as claimed in claim 1, wherein said a handle is respectively set on the respective corresponding-position of the side rack of the first and the second ladder structure.

10. A loading ramps structure as claimed in claim 1, wherein said the handle includes the lateral holding section and the vertical fastening sections on both ends; the vertical fastening section extends through penetrated hole of the side rack of the first or the second ladder structure and forms a block section, whose lateral width is larger than the penetrated hole, on the other end of the penetrated hole.
